(19) United States
(12) Patent Application Publication
(10) Pub. No.: US 2003/0023759 A1
(43) Pub. Date: Jan. 30, 2003

(54) System and method for provisioning telephony services via a personal digital assistant

(76) Inventors: Jack Littleton, Gilroy, CA (US); Danilo Unite, Santa Clara, CA (US)

Correspondence Address: BLAKELY, SOKOLOFF, TAYLOR & ZAFMAN LLP, 12400 Wilshire Boulevard, Seventh Floor, Los Angeles, CA, 90025, US

(21) Appl. No.: 09/729,622

(22) Filed: Nov. 30, 2000

(51) Int. Cl. G06F 15/16

(52) U.S. Cl. 709/248

(57) ABSTRACT

A system and related method are described for synchronizing information on a handheld computer with information on a database maintained by a server. The handheld computer includes a first application program to maintain a first database and a second application program to enable a user to access the first database and change records in the first database according to features selected by the user. The system also includes a synchronization program running on a host computer system to synchronize the first database on the handheld computer with a server database.

### BACKGROUND OF THE INVENTION

1. Field of the Invention

The present invention generally relates to synchronization of information between a wireless portable device and a server, and in particular, to a system and corresponding method for provisioning telephony services via a personal digital assistant.

2. Description of the Related Art

Wireless portable devices or handheld computers such as a personal digital assistant (PDA) may be used for various purposes, including manage personal information and communications. Typically, a user of PDA runs Personal Information Manager (PIM) programs to manage address book information, scheduling and to perform other tasks. Users of PDA may also use a personal computer to manage data similar to the data carried in the PDA. In this regard, a user can add or modify personal data using either a PDA or a personal computer. For example, information can be entered into the PDA when the user is at a remote location away from a personal computer. Thereafter, the PDA can be connected to the personal computer in order to update the data in the personal computer with the latest updates made by the user, and vice versa. This may be achieved with a PIM software resides on he personal computer that can be coupled to the PIM software on PDA in order to share information with the PDA.

Presently, telephone service features such as call waiting, call forwarding, call blocking, caller ID block, distinctive ring, anonymous call reject and other telephone related services can be selectively modified by a user. In one implementation, a subscriber of telephone provisioning services may connect to a web site providing such services to selectively change telephone service settings. Situations may arise in which the subscriber may desire to change telephone service features in remote locations. For example, if the subscriber meets someone at a remote location (e.g., tradeshow) and desires to add information about that person into his/her address book using a handheld computer (e.g., PDA). At the same time, the subscriber may also desire to set telephone provisioning features with respect to that particular person. However, currently, there is no effective device or method for enabling a subscriber to modify telephone service features unless the subscriber is sitting at a computer having access to a web site providing such telephone provisioning services.

### SUMMARY OF THE INVENTION

In accordance with one embodiment of the present invention, a system is provided for synchronizing information on a handheld computer with information on a database maintained by a server. The handheld computer includes a first application program to maintain a first database and a second application program to enable a user to access the first database and change records in the first database according to features selected by the user. The system also includes a synchronization program running on a host computer system to synchronize the first database on the handheld computer with a server database.

In one implementation, the second application program enables a user of the handheld computer to view and set telephone service features for those contacts that appear in the first database using the handheld computer.

### BRIEF DESCRIPTION OF THE DRAWINGS

FIG. 1 is a block diagram of a synchronization system according to one embodiment of the present invention.

FIG. 2 is a flowchart of operations of a telephone-provisioning program according to one embodiment of the invention.

FIG. 3 is a flowchart of operations of a synchronization program according to one embodiment of the invention.

FIG. 4 is a block diagram of a synchronization system according to another embodiment of the invention.

### DETAILED DESCRIPTION OF THE INVENTION

Implementations of the present invention are described herein for purposes of illustration, namely a method and a corresponding system for synchronizing information residing on a handheld computer and information residing on a server database. According to one aspect of the invention, the present invention enables a user to set telephone related provisioning information via a handheld computing device. According to another aspect of the invention, an address book database managed by a PIM program is used to store information related to telephone service features selected by a user. According to a further aspect of the invention, the telephone provisioning is applied to the user's existing address book database on the PDA without interfering with the user's use of existing PIM programs.

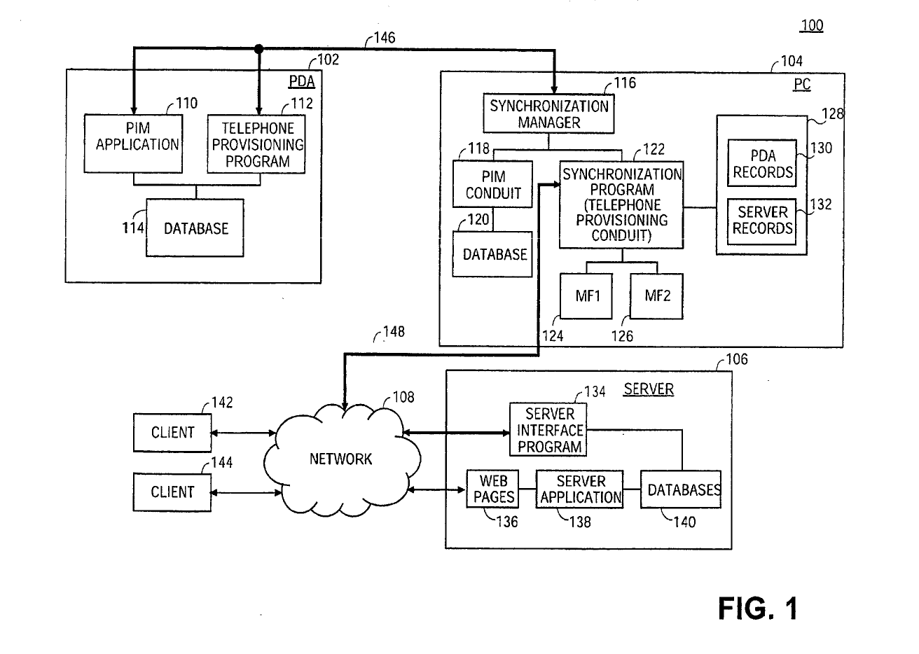

FIG. 1 depicts a system 100 for provisioning telephone services features via a handheld computer according to one embodiment of the invention. Included in the system 100 are a handheld computer such as a Personal Digital Assistants (PDA) 102, a host computer such as a personal computer (PC) 104, a server 106 and a network 108 for coupling the PC to the server. In one implementation, the PDA 102 is a palmtop computer configured to provide functions for personal organization (address book database, calendar, note talking, and the like) as well as communications. The PDA 102 includes Personal Information Manager (PIM) application 110, a telephone-provisioning program 112 and a database 114 accessible by both the PIM application and the telephone-provisioning program.

The PIM application 110 residing on the PDA 102 includes an address book application for organizing personal information such as names, addresses, phone numbers and the like. The PIM application 110 on the PDA 102 may also include other software programs, such as data book application, notepad and applications for organizing to do lists, calendar and the like. For the purpose of illustration, the present invention is described in conjunction with an address book application and an address book database on the PDA; however, it should be understood by those skilled in the art that the present invention could be easily modified for use with other PIM application and database residing on a PDA.

The PIM data generated by the PIM application 110 is typically organized in the form of database records. One type of database managed by the PIM application is an address book database. The address book database includes a number of records, each record containing a number of data fields for storing information about user's contact such as names, addresses, phone numbers, etc. In one embodiment, the telephone-provisioning program 112 and the PIM application (e.g., address book application) 110 share the same database (e.g., address book database).

The PDA 102 and the PC 104 are connectable via a communications link 146 such as a serial cable. Included in the PC 104 are a synchronization manager 116 and a Personal Information Manager (PIM) conduit 118. The PIM conduit 118 is configured to be coupled with the PIM application 110 on PDA 102 to synchronize data on the PC and the PDA. Also included in the PC 104 is a synchronization program 122 (also referred hereinafter as “telephone-provisioning conduit”) configured to synchronize information residing on the PDA database 114 with information residing on a server database 140.

One way to access the database 114 residing on the PDA 102 is through the PIM application 110 residing on the PDA 102 via the synchronization program (telephone-provisioning conduit) 122 running on the PC 104. However, doing so would prevent a user from using the existing PIM conduit 118 on the PC since the synchronization manager 116 only permits one conduit software running on PC to be associated with one application running on the PDA. Only one conduit software program (e.g., PIM conduit 118 or telephone-provisioning conduit 122) on the PC 104 can be associated with the PIM application 100 on the PDA. Typically, a PIM conduit on a PC and a PIM application on a PDA are linked together by what is referred to as a signature that indicates that the PIM conduit belongs to the PIM application. One important function the PIM conduit and the PIM application serve is to provide synchronization between a database on the PDA and a database on the PC.

Consequently, if the telephone-provisioning conduit 122 on the PC 104 is associated with the PIM application 110 on the PDA 102, no other conduit software (e.g., PIM conduit 118) on the PC could be associated with the PIM application and as a result the PIM conduit on the user's PC could no longer perform synchronization with the PIM application on the PDA. In order to overcome this problem, the telephone-provisioning conduit 122 on the PC 104 is adapted to be linked with the telephone-provisioning program 112 on the PDA instead of being linked with the PIM application. This allows the telephone-provisioning conduit 122 to access records from the database 114 on the PDA via the telephone-provisioning program 112 on the PDA. Accordingly, the telephone-provisioning program 112 and the telephone-provisioning conduit 122 of the present invention advantageously do not interfere with a user's use of existing PIM software residing on the PC such as Palm Desktop™, Microsoft Outlook™, Act™, etc.

The PC 104 is connectable to a server 106 over a network 108 (e.g., Internet) via a network communications link 148. The server 106 includes web pages 136 to allow clients 142, 144 connected via the Internet to interact with and selectively configure their telephone provisioning features. The server 106 uses a server application 138 to receive client inputs and to maintain a database 140 based on information (e.g., telephone provisioning related data) received from the clients. The server 106 also includes a server interface program 134 for interfacing the synchronization program (telephone-provisioning conduit) 122 with the server database 140.

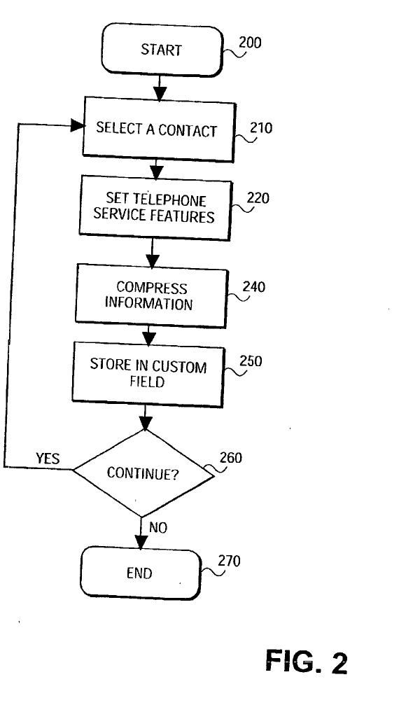

FIG. 2 depicts operations of the telephone-provisioning program 112 according to one embodiment of the invention. The telephone-provisioning program 112 includes a user interface to enable a user of a PDA to view and set telephone service features for those contacts that appear in the address book database 114 using the PDA 102. Because the PDA 102 can be easily carried around, the user of the PDA can conveniently access and update address book information as well as telephone service features in remote locations away from their PCs. Once the telephone-provisioning program 112 has been executed by a user in block 200, a list of names of those contacts that are included in the address book database will appear on the PDA display screen. In block 210, the user may select a contact whose telephone service features the user wants to modify. In this regard, when the user select a name displayed on the PDA screen, a list of different telephone service features will be displayed on the PDA. display screen. In block 220, the user can selectively set various telephone service features by interacting with the user interface of the telephone-provisioning program 112. Examples of telephone services that can be modified include, but are not limited to, call waiting, call forwarding, call blocking, caller ID block, distinctive ring, anonymous call reject and other telephone related services. By incorporating the telephone-provisioning program 112 in the PDA 102, the present invention provides a user with the ability to set telephone service features at remote locations while the user is thinking about them as opposed to requiring the user to wait until the user has an Internet connection to access a web site providing such telephone provisioning services.

In one implementation, data related to telephone service features selected by the user is stored in one of the custom fields of the address book records. Typically, each record of the address book database 114 contains a number of custom fields. For example, one custom field may be designated for storing birthday information. The telephone-provisioning program 112 enables a user to designate one of the custom fields for storing a coded string message that describes what telephone service features were selected for that particular contact.

Typically, each record in the address book database is adapted to contain up to certain number of phone numbers for each contact (e.g., five). For each phone number contained in a record, there are a number of different telephone service features that can be set including call screening, call forwarding, acceptance, speed dial, and distinctive ring. Some telephone provisioning features effect the entire record such as the call blocking feature while other telephone provisioning features such as the speed dial and distinctive ring features can be set for individual telephone numbers.

In block 240, the telephone-provisioning program 112 compresses the selected telephone service feature information for all phone numbers contained in a record into a compressed coded string message. By compressing telephone service feature information into a coded string message, the telephone-provisioning program 112 is able to store all different attribute combinations for all phone numbers in a record into a single custom field in block 250. At this point, if the user wishes to continue setting telephone service features for other contacts in the address book database (decision block 260, yes), the program 112 returns to the beginning of this loop (block 210). This loop (blocks 210-260) is continued until the user terminates the program 112 in block 270.

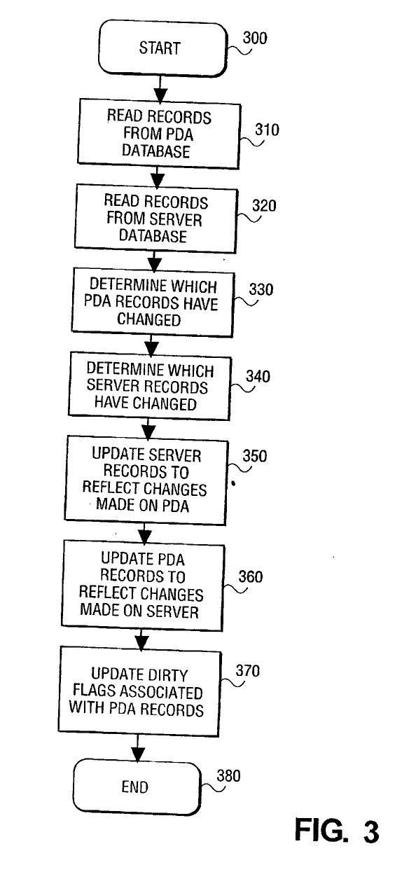

FIG. 3 depicts operations of the synchronization program (telephone-provisioning conduit) 122 according to one embodiment of the invention. Once a user has changed telephone service features using the PDA, the changes will not become effective until telephone service provisioning on PDA is synchronized with telephone provisioning information on the server. When a user desires to synchronize information on the PDA database 114 with information on the server database 140, the synchronization manager 116 residing on the PC 104 is initiated in response to a user actuating a synchronization button on the PDA 102. The synchronization manager 116 is aware of all synchronization software including the PIM conduit 118 and the telephone-provisioning conduit 112 on the PC, and it queries the PDA 102 to determine if there are matching applications. Because the telephone-provisioning conduit 122 and the telephone-provisioning program 112 are linked together by a signature, the synchronization manager 116 will execute the telephone-provisioning conduit 122 on the PC as well as the telephone-provisioning program 112 on PDA in response to the user actuation of the synchronization switch.

Once the telephone-provisioning conduit 122 has been executed in block 300, each individual record from the address book database 114 is read from the PDA 102 in block 310. The records from PDA are formatted and stored locally on the PC. In one implementation, because retrieving records from the PDA is faster than retrieving records from the server database, the telephone-provisioning conduit 122 will retrieve all records from the PDA database. Then in block 320, the records from the server database 140 are read and stored locally on the PC.

The telephone-provisioning conduit 122 is operable either in a fast synchronization mode or in a slow synchronization mode. In the fast synchronization mode, only those records that the server knows are modified are retrieved by the telephone-provisioning conduit. Additionally, if there are records that have been modified on the PDA side but the corresponding records (i.e., record with same identification number) are not included in the list of records that came down initially from the server, the telephone-provisioning conduit will request that those records be fetched from the server database. In the slow synchronization mode, all records from the server database are read by the telephone-provisioning conduit.

In block 330, the telephone-provisioning conduit 122 determines which PDA records have been modified by comparing checksum values of the PDA records with the checksum values stored in a first map file (MF1) 124. In block 340, the telephone-provisioning conduit 122 also determines which server records have been modified by comparing checksum values of the server records with the checksum values stored in a second map file (MF2) 126. The use of checksum values to identify modified records will be discussed in more detail below.

In block 350, the telephone-provisioning conduit 122 updates server records to reflect changes made on PDA. At this point, the telephone-provisioning conduit will extracts the compressed coded string message from the custom field of each modified record and forward the extracted data to the server interface program 134. When the server interface program 134 receives the coded string message, it translates the codes string message by parsing, decoding and converting the data into appropriate database commands to update the server database so as to reflect changes made by the user on the PDA. The telephone-provisioning conduit is also configured to update records in the PDA database to reflect changes made directly on the web server 106 in block 360.

Typically, dirty flags are maintained by the PIM application 110 on the PDA 102 to indicate which records in the database have been recently created, modified or deleted since previous synchronization. For example, if a user changes a record on the PDA 102, the PIM application 110 will set a modified bit in the dirty flag associated with that record to indicate that the record has been modified. During synchronization between the PDA 102 and PC 104, the dirty flags are used to determine which records need to be updated or created in the other device and once the synchronization process has been completed, the dirty flags are then cleared.

During synchronization between the PDA database 114 and the server database 140, one way to identify modified or new records is to rely on dirty flags associated with records in the PDA's address book database 114. However, dirty flags cannot always be relied upon, since the dirty flags are cleared once the synchronization process between the PDA and the PC is completed.

Accordingly, rather than relying on dirty flags, the telephone-provisioning conduit 122 of the present invention uses checksum values to determine which records are new or have changed. By using checksum values to identify new or modified records, the present invention does not depend on dirty flags maintained by the PIM application 110 residing on the PDA. Specifically, the telephone-provisioning conduit 122 maintains two map files, a first map file (MF1) to keep track of PDA records and a second map file (MF2) to keep track of server records. Each map file contains a number of entries, each entry including a checksum value and an identification number (ID) to indicate which record the checksum value is associated with. The checksums contained in the map files are derived during previous synchronization by combining all the bytes of data in each record using a series of arithmetic or logical operations.

As a record is read in during synchronization process, a checksum value is computed for that record and is compared with one of the checksum values contained in the map files that is associated with same record identification number to determine if the record has been modified since the previous synchronization. If the checksum value of a record does not match the checksum value in the map files, the record will be presumed to be modified. If the identification number of a record does not match any of the entries contained in the map files, the record will be presumed to be new. During this synchronization process, the map files get updated with computed checksum values of the modified and new records.

Because new records can be created or existing records can be modified on the PDA during synchronization between the PDA and the server, it is desirable that the dirty flags associated with such new or modified records get updated to accurately reflect the current status. Accordingly, the telephone-provisioning conduit 122 is configured to update the dirty flags associated with address book records to reflect changes made during synchronization between the PDA database and the server database by manually setting the dirty flags associated with modified or new records. For example, if the telephone-provisioning conduit determines that a record in the PDA's address book database needs to be modified, the telephone-provisioning conduit will update the dirty flag to reflect modified state of such record (block 370 of FIG. 3).

When a user deletes a record from a PDA database, that record does not actually get deleted until the PDA is synchronized with a PC. During synchronization, the PIM conduit 118 on the PC will examine the dirty flags to determine which records have been deleted and will delete corresponding records from the PC database and PDA. Accordingly, when the telephone-provisioning conduit 122 identifies a record that has been deleted from the server database, a deleted bit of a dirty flag associated with the deleted record will be set in the PDA database. In this regard, if the user subsequently decides to synchronize the PDA and PC, the PIM conduit 118 on PC will recognize that such record has been deleted based on the information provided by the dirty flag.

The telephone-provisioning program 112 is also configured to allow a user to select what takes place when a record is modified both on the PDA and the server. For example, if a user chooses to let the PDA record to override the server record, the updates made to the PDA record will take precedence over updates made on the server, and vice versa.

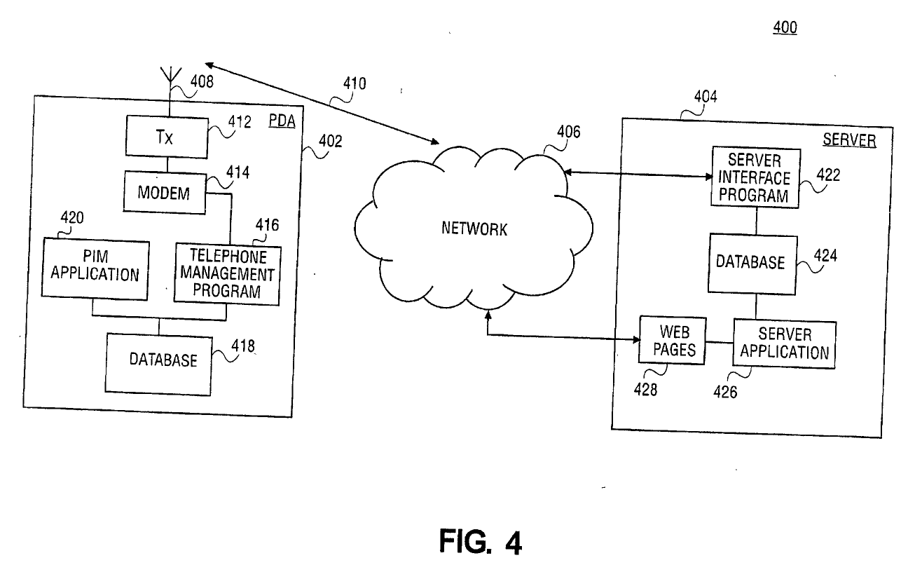

FIG. 4 depicts a system 400 for provisioning telephone service features via a personal digital assistant according to another embodiment of the invention. In this embodiment, a PDA 402 is in communication with a server 404 over a network 406 (e.g., Internet) via a wireless communications link 410. In use, once a user has modified telephone service features using the PDA, the modified record can be transmitted to the server 404 wirelessly. In one implementation, the PDA 402 is configured to send a single record that the user was modifying at the time of send. This enables telephone service changes to take place immediately. In this embodiment, the PDA 402 includes components to establish a wireless communications link 410 with the server 404. For example, the PDA 402 may employ a modem 414 and a transmitter 412 to transmit information provided by the telephone management program to the server over the wireless communications link 410. In another implementation, the PDA 402 includes a synchronization program to perform synchronization between the PDA database 418 and the server database 424 wirelessly.

Although the illustrated embodiment is described in terms of a PDA, it will be appreciated by those skilled in the art that the synchronization system of the present invention can be carried out using other types of handheld computers. Such is within the scope and contemplation of the present invention.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. A system comprising:
a handheld computer including a first application program to maintain a first database, and a second application program to enable a user to access said first database and change records in said first database according to features selected by the user; and
a host computer system including a synchronization program to provide a synchronization of information on said first database and information on a second database maintained by a server.

2. The system of claim 1, wherein said synchronization program maintains a map file of checksum values to determine which records are new and which records have changed since previous synchronization.

3. The system of claim 1, wherein said synchronization program is configured to update dirty flags maintained by said first application program to reflect changes made during synchronization between said handheld computer and said server.

4. The system of claim 1, wherein said handheld computer is a personal digital assistant.

5. The system of claim 1, wherein said first application program is a Personal Information Manager and said first database is an address book database.

6. The system of claim 5, wherein said second application program is a telephone management application program to enable a user to select telephone service features for those contacts that appear in the address book database.

7. The system of claim 6, wherein said telephone service features selectable by a user includes at least one of call waiting, call forwarding, call blocking, caller ID block, distinctive ring and anonymous call reject.

8. The system of claim 1, wherein said host computer system further comprises a Personal Information Manager to maintain records in a second address book database.

9. A method comprising:
providing a first application program on a handheld computer to maintain a first database;
providing a second application program on a handheld computer to enable a user to access said first database and change records in said first database according to features selected by the user; and
using a host computer system to synchronize information on said handheld computer with information maintained by a server.

10. The method of claim 9, wherein said using a host computer to synchronize information further comprises:
reading records of said first database from said handheld computer;
determining which records of said first database have been modified;
reading modified records of a second database maintained by a server;
updating records of said second database to reflect changes made to said modified records of said first database; and
updating records of said first database to reflect changes made to said modified records of said second database.

11. The method of claim 9, further comprising maintaining a map file of checksum values, each checksum value corresponds to a respective record of said first database, said checksum values useful in determining which records are new and have changed.

12. The method of claim 9, further comprising updating dirty flags maintained by said first application program to reflect changes made during synchronization between said handheld computer and said server.

13. The method of claim 9, wherein said handheld computer is a personal digital assistant.

14. The method of claim 9, wherein said first application program is a Personal Information Manager and said first database is an address book database.

15. The method of claim 9, wherein said second application program is a telephone management application program to enable a user to select telephone service features for those contacts that appear in the address book database.

16. The method of claim 15, wherein said telephone service features selectable by a user includes at least one of call waiting, call forwarding, call blocking, caller ID block, distinctive ring and anonymous call reject.

17. The method of claim 9, wherein said host computer system further comprises a Personal Information Manager to maintain records in a second address book database.

18. A machine-readable medium that provides instructions, which when executed by a processor, cause said processor to perform operations comprising:
reading records of a first database on a handheld computer;
determining which records of said first database have been changed;
reading records of a second database maintained by a server;
determining which records of said second database have been changed;
updating records of said second database to reflect changes made to records of said first database; and
updating records of said first database to reflect changes made to records of said second database.

19. The machine-readable medium of claim 18, wherein operations further comprise maintaining a first map file of checksum values, each checksum value of said first map file corresponds to a respective record of said first database, said checksum values are used in determining which records have changed.

20. The machine-readable medium of claim 19, wherein operations further comprise maintaining a second map file of checksum values, each checksum value of said second map file corresponds to a respective record of said second database, said checksum values are used in determining which records have changed.

21. The machine-readable medium of claim 18, wherein operations further comprise updating dirty flags maintained by said first application program to reflect changes made during synchronization between said handheld computer and said server.

22. A handheld computer comprising:
a first application to maintain a first database;
a second application to enable a user to access said first database and change a record in said first database according to features selected by the user; and
a wireless communications link with a server, wherein said hand held computer is configured to communicate information associated with said features selected by the user to said server over said wireless communications link.

23. The handheld computer of claim 22, wherein said first application is a Personal Information Manager and said first database is an address book database.

24. The handheld computer of claim 23, wherein said second application is a telephone management application to enable a user to select telephone service features for those contacts that appear in said address book database.

25. The handheld computer of claim 24, wherein said telephone service features selectable by the user includes at least one of call waiting, call forwarding, call blocking, caller ID block, distinctive ring and anonymous call reject.

26. The handheld computer of claim 22, wherein said handheld computer is a personal digital assistant.
